(19) United States
(12) Patent Application Publication
(10) Pub. No.: US 2026/0048441 A1
(43) Pub. Date: Feb. 19, 2026

(54) SHELL CUTTER WITH REPLACEABLE INSERTS

(71) Applicant: Mueller International, LLC, Atlanta, GA (US)

(72) Inventors: Mohammad Unnus Qasim, Decatur, IL (US); David Latimore Hughes, JR., Signal Mountain, TN (US); Yixin Li, Sugar Land, TX (US); Ryan Fairchild Larson, Decatur, IL (US)

(21) Appl. No.: 18/804,632

(22) Filed: Aug. 14, 2024

(51) Int. Cl. B23B 51/04

(52) U.S. Cl. CPC B23B 51/0466

(57) ABSTRACT

A rotary shell cutter tool can include a cylindrical body defining a center axis extending through the body that further defines a cutting face, a cutting insert, and a cutting recess defined in the cutting face that extends axially into the cylindrical body from the cutting face. The cutting recess can be configured to receive the cutting insert. The rotary shell cutter tool can be configured to have replaceable cutting inserts which can be attached to the shell cutter via a flexure.

### TECHNICAL FIELD

### Field of Use

The present disclosure generally relates to shell cutter tools. More specifically, the present disclosure relates to shell cutter tools having replaceable cutting inserts.

### Related Art

In contemporary drilling for construction operations such as water or gas applications, the use of cutting tools is paramount. Shell cutters, which are hole saw-like devices configured to cut holes in a material (often pipelines constructed of metal such as iron or steel) and are also known as rotary cutting tools, are often equipped with hardened high-speed steel or carbide teeth to engage and cut. However, the use of such permanently affixed cutting mechanisms presents a significant challenge in terms of both manufacturing costs and operational efficiency. The current manufacturing process involves brazing or welding these cutting mechanisms, such as cutting teeth or inserts, into place and subsequently custom grinding them, contributing to a notably high production expense and decreased serviceability.

Additionally, when these shell cutters experience wear or damage in the field, the operator's only course of action is to send them back to the manufacturer or dedicated tool repair company for repair or resharpening. Unfortunately, when an operator is forced to send the tools in for service, they almost always met with unacceptably long downtimes as a result of slow service turnaround. Often, and particularly during emergencies, long wait times create a cascade of delays and inconveniences, leaving operators with limited options and missed deadlines. In such critical situations, customers are faced with the dilemma of either deploying a backup cutter, suspending the ongoing operation until the original cutter is restored or resorting to the costly flexure of expedited orders for replacement cutters.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a rotary cutting tool comprising: a substantially cylindrical body defining a center axis extending therethrough; the body comprising a cutting face; a cutting insert; and a cutting recess defined in the cutting face, the cutting recess extending axially into the substantially cylindrical body from the cutting face, the cutting recess can be configured to receive therein the cutting insert.

In a further aspect, disclosed is a method of securing a cutting insert to a rotary tool, the method comprising: providing a rotary cutting tool comprising a substantially cylindrical body, a cutting face, a cutting recess, and a first cutting insert; engaging a cam tool with the rotary cutting tool at a cutting recess; articulating the cam tool to elastically deform the cutting recess and release a clamping force; replacing the first cutting insert with a second cutting insert; and releasing the cam tool.

In yet another aspect, disclosed is a cutting tool comprising: obtaining a tool comprising: an annular body rotatably centered about an axis, the body defining a distal end and a proximal end comprising a cutting face; a plurality of cutting recesses defined circumferentially about the cutting face, each cutting recess defining a void; and a cutting insert disposed in the void of each cutting recess, the cutting insert sizably configured to form an interference fit with the void.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and together with the description, serve to explain various principles of the disclosure. The drawings are not necessarily drawn to scale. Corresponding features and components throughout the figures may be designated by matching reference characters for the sake of consistency and clarity.

FIG. 1 is a frontal perspective view of a cutting tool in accordance with one aspect of the present disclosure.

FIG. 1 is a frontal perspective view of a cutting insert compatible with the cutting tool of FIG. 1.

FIG. 2 is a frontal perspective view of the cutting tool of FIG. 1 with a plurality of the cutting insert of FIG. 2 attached thereto.

FIG. 3 frontal perspective view of a cutting tool in accordance with another aspect of the present disclosure.

FIG. 5 is a detail view of a retention mechanism of the cutting tool of FIG. 4 shown from detail 5 in FIG. 4.

FIG. 6 is a perspective view of a cam tool in accordance with one aspect of the present disclosure.

FIG. 7 is a perspective view of a cutting insert in accordance with another aspect of the present disclosure.

FIG. 8 is a frontal perspective view of the cutting tool of FIG. 4 and with a plurality of the cutting insert of FIG. 7 disposed in a plurality of the cutting recess of FIG. 4, with the cutting tool in engagement with the cam tool of FIG. 6 in accordance with one aspect of the present disclosure.

FIG. 9 is a frontal perspective view of yet another aspect of a cutting tool in accordance with another aspect of the present disclosure.

FIG. 10 is a side perspective view of yet another aspect of a cutting insert in accordance with another aspect of the present disclosure.

FIG. 11 is an elevated perspective view of the cutting tool of FIG. 9 with a plurality of the cutting insert of FIG. 10, with the cutting tool in engagement with the cam tool of FIG. 6.

FIG. 12 is an isometric view of yet another aspect of a cutting recess and cutting insert in accordance with another aspect of the present disclosure.

FIG. 13 is a frontal perspective view of the cutting recess and cutting insert of FIG. 12 in accordance with a yet another aspect of the present disclosure.

FIG. 14 is an isometric view of yet another aspect of a cutting recess in accordance with another aspect of the present disclosure.

FIG. 15 is an isometric view of yet another aspect of a flexure cutting insert in accordance with another aspect of the present disclosure.

FIG. 16 is a perspective view of a cutting recess in accordance with another aspect of the present disclosure.

FIG. 17 is a top view of the cutting recess of FIG. 16.

FIG. 18 is a perspective view of the cutting recess of FIG. 16 with another aspect of a cutting insert installed thereon.

FIG. 19 is a top view of the cutting recess of FIG. 16 in accordance with another aspect of the present disclosure.

FIG. 20 is a top view of the cutting insert of FIG. 18.

FIG. 21 is a front view of the cutting insert of FIG. 18.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the present disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of a tool nearest to and facing a recess in the tool sized to receive a detent member; “rear” is that end of the tool head which can be opposite or distal the front; “left” is that which is to the left of or facing left from a person facing towards the front; and “right” is that which is to the right of or facing right from that same person facing towards the front. “Horizontal” or “horizontal orientation” describes that which is in a plane extending from left to right and aligned with the horizon. “Vertical” or “vertical orientation” describes that which is in a plane which can be angled at 90 degrees to the horizontal.

In one aspect, a rotary cutting tool and associated methods, systems, devices, and various apparatuses are disclosed herein. In some aspects a shell cutter and associated methods, systems, devices and various apparatuses are disclosed herein. The shell cutter can include a body which can be geometrically configured for cutting. In some aspects, the body is substantially cylindrical, and can include a hollow center. In some aspects, the body can comprise a cutting face. The cutting face can be configured to contain thereon a plurality of cutting recesses which can extend axially therefrom. The cutting recesses can be spaced equidistantly apart from each other about the periphery of the cutting face. In some aspects, the cutting recesses can be configured to receive a cutting insert. It is envisioned that the cutting insert can be configured to cut a workpiece.

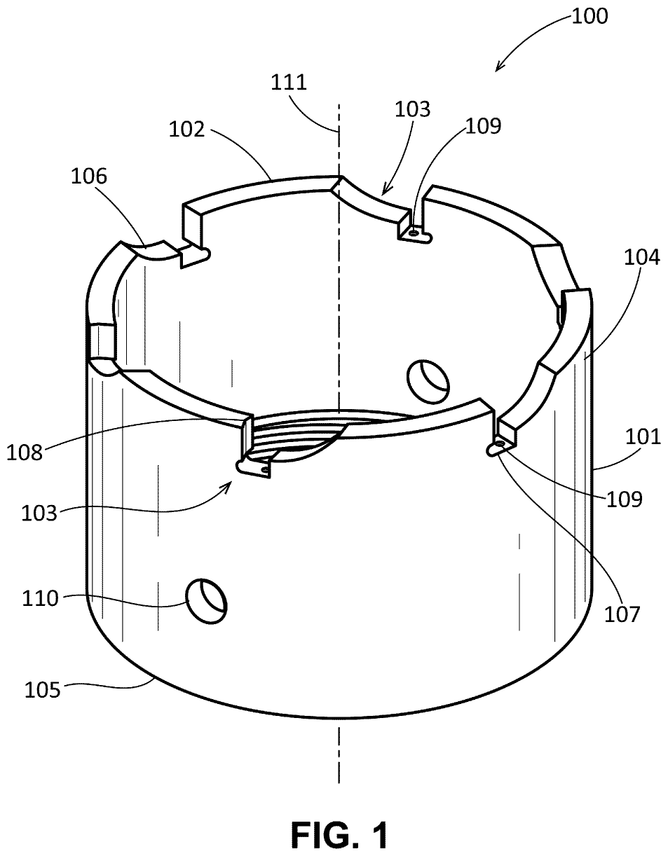

Turning now to FIG. 1, a shell cutter 100 in accordance with an aspect of the present disclosure is provided. In some aspects, the shell cutter 100 is an extraction device, such as, for example, a pipe coupon extraction tool or pipe coupon retainer. In some aspects, as shown, the shell cutter 100 can be a cutting apparatus, hole saw apparatus, drilling apparatus, or pipe cutter in accordance with various aspects of the present disclosure. For example, the shell cutter 100 can be operable to cut a substantially circular coupon from a pipe. In another example, the shell cutter 100 can resemble a hole saw which can be used in combination with a power tool, such as a drill or other power rotary tools, to cut a substantially circular hole in a workpiece. In some aspects, the shell cutter 100 comprises a substantially cylindrical body 101 which can be defined by an extruded annulus having a hollow center. The diameter of the body 101 can be sizably configured based on the diameter of the hole to be cut. The body 101 can be constructed from a substantially heat resistant and resilient material, such as steel, tool steel, sintered metal, or the like. The body 101 can extend axially about an axis 111 and define a cutting end 104 and a distal end 105. The body 101 can define one or more expansion holes 110 disposed between the cutting end 104 and the distal end 105 which can be configured to relieve a stress experienced from thermal expansion during, for example, a cutting event. Further, the expansion holes 110 can also be configured to reduce vibration during a cutting operation. In some aspects, the expansion holes can be structured to create a space for the body 101 to occupy during a thermal expansion event. Such thermal expansion event can occur as a result of heat transferred during the cutting operation.

The distal end 105 of the body 101 can include a structure which can be configured to mechanically engage with a power tool configured to provide rotary motion from the power tool such as, for example, a power drill. In some aspects, the structure can comprise threads disposed on the distal end 105 of the body. The threads can be configured to engage with, for example, a power tool. In some aspects, the structure can be a post configured to be received by, for example, a drill chuck. In some aspects, the structure can be an extruded hexagon. The cutting end 104 of the body 101 can include a cutting face 102 which can be operable to engage with a workpiece during the cutting operation. The cutting face 102 can be formed from a wear and heat resistant material. The cutting face 102 can be formed of the same material as the body but can be treated, such as, for example, work hardened or heat treated. In some aspects, the cutting face 102 can include one or more cutting recesses 103. It is envisioned that the cutting recesses 103 can be spaced equidistantly apart from one another about the periphery of the cutting face 102. In some aspects, the number of cutting recesses 103 can be configurable based on one of the rotational speeds of the shell cutter 100, hardness of the materials to be cut, or other workpiece or tool material limits.

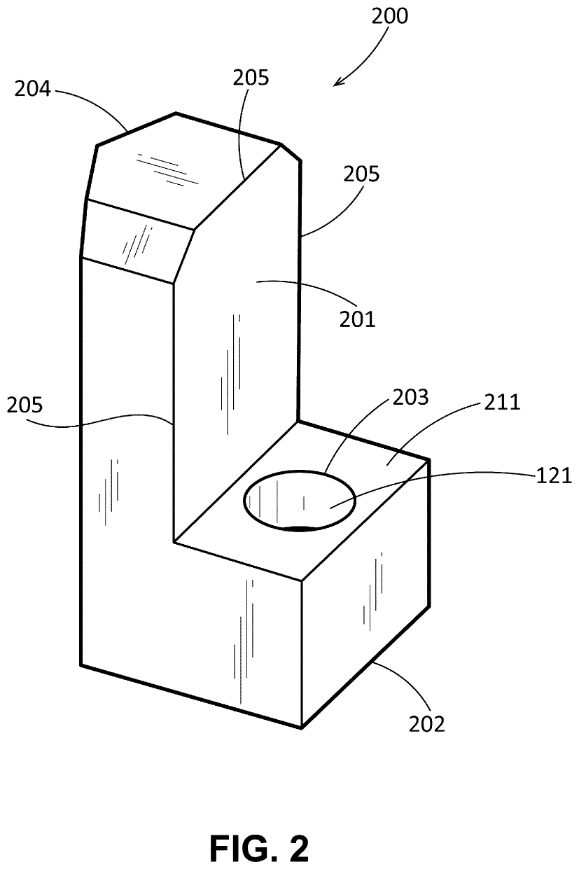

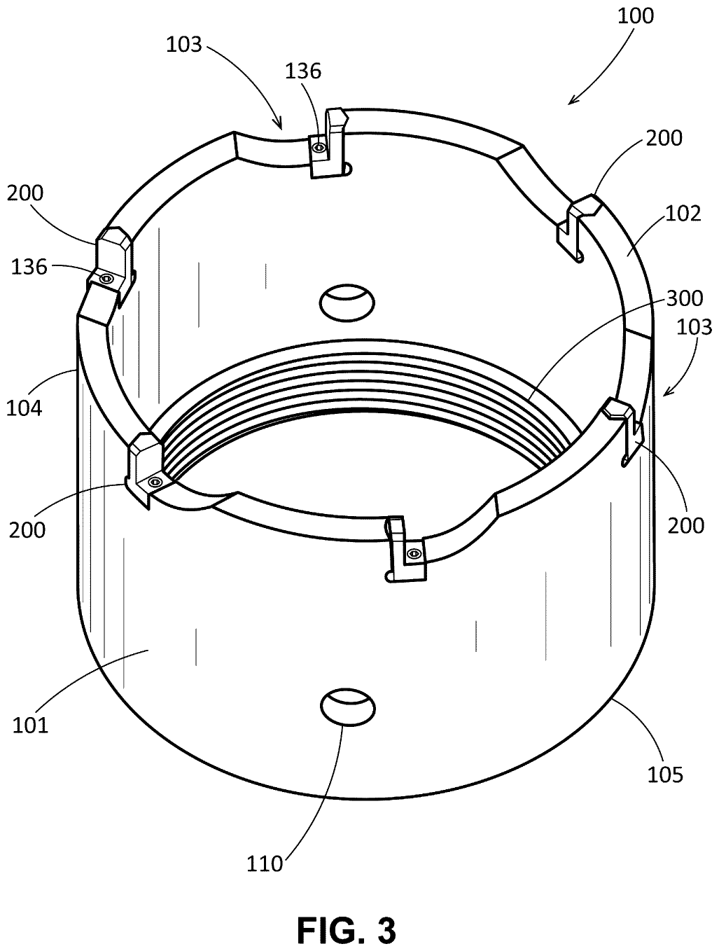

Each cutting recess 103 can further define a cutting relief 106 that, in some aspects, can be operable to remove chips or other debris from cutting. Further, it is envisioned that the cutting relief 106 can be structured to provide a kerf during cutting. In some aspects, a kerf can define a width of cut created by a mechanism, such as a cutting tooth, wherein the width of cut is greater than the width of the body of the cutting tool. For example, the cutting tool 100 can be configured to form a cut defining a width greater than the cutting tool 100. In some aspects, the kerf which can be created by the cutting relief 106 can define a width that can be greater than the width of the cutting recess 103. The cutting recess 103 can further comprise a base 107 which can comprise a fastening mechanism, such as a recess fastener hole 109. In various aspects, the recess fastener hole 109 can be a threaded hole. It is envisioned that the recess fastener hole 109 can be configured to receive therein a fastener, such as a cutter bolt 136 (shown in FIG. 3) that can be threaded. In aspects where the fastener recess hole 109 is a threaded hole, threading on the threaded hole can engage threading on the cutter bolt 136. A locating feature 108 can be disposed in the cutting recess 103 in some aspects. It is envisioned that the locating feature 108 can be structured to secure a cutting insert 200 (shown in FIG. 2). The cutter 100 can be configured to cut a first hole defining a first diameter. As shown, the parts of the shell cutter 100 can be in mechanical communication with each other.

Turning now to FIG. 2, the cutting insert 200 is shown in accordance with one aspect of the current disclosure. The cutting insert 200 can be constructed from a substantially hard material which can be configured to machine a workpiece. For example and without limitation, the cutting insert 200 can be constructed from any of carbide, tungsten carbide, high speed steel, ceramic, ceramic-metal composite, coated carbides, cubic boron nitride, sintered metallic material, sintered powder metal, diamond, polycrystalline diamond, and nitrated alloys. In some aspects, the cutting insert 200 is sizably configured to be received by the cutting recess 103 of the shell cutter 100. In some aspects, the shell cutter 100 can comprise a plurality of cutting inserts 200 disposed thereon. In some aspects, the cutting insert 200 further comprises a cutting face 201 which can be disposed at an angle relative to a workpiece surface, wherein the angle can be configured such that at the instant of engagement between the cutting face 201 and workpiece surface, the cutting face 201 can create a shearing force and remove material therefrom while remaining undeformed. In some aspects, the angle can define a rake angle relative to the workpiece. In some aspects, the cutting face 201 defines a width greater than a width of the cutting recess 103 of the shell cutter 100.

In some aspects, the cutting insert 200 can comprise an insert base 202 which can be configured to be received by the cutting recess 103. The base 202 can comprise a bolt portion 121 defining an insert fastener hole 203 that extends therethrough and can be configured to engage with a fastener. A fastener, such as cutter bolt 136, can be used to secure the cutting insert 200 onto the cutting recess 103 of the shell cutter 100. In some aspects, the cutting insert 200 is secured within the cutting recess 103 via a cutter bolt 136 (shown in FIG. 3), although other fasteners can be used in other aspects. The cutter bolt 136 can be configured to extend through bolt portion 121 of the cutting insert 200. The cutter bolt 136 can be configured to be flush with the cutting insert 200 when installed. In various aspects, the cutter bolt 136 can extend through the bolt portion 121 of the cutting insert 200. In some aspects, the cutter bolt 136 can be flush with an upper surface 211 of the bolt portion 121 of the cutting insert 200. In some aspects, the cutting insert 200 can comprise an insert locating feature 204 which can be substantially centered on the cutting insert 200 on a side opposite the cutting face 201. The insert locating feature 204 can be configured to locate the cutting insert 200 in the cutting recess 103 of the shell cutter 100. In some aspects, the insert locating feature 204 can define a surface defined by a nonplanar profile which can be received by the locating feature 108 of the cutting recess 103. In some aspects, the insert locating feature 204 can be substantially V-shaped. In some aspects, the insert locating feature 204 can comprise a male feature which can be configured to be received by a matching female feature defined on the locating feature 108. In some aspects, the cutting insert 200 can comprise a cutting edge 205. The cutting edge 205 can be configured to machine or cut a workpiece. In some aspects, the cutting edge 205 can comprise a sharpened edge which can be structed to machine a surface. The cutting insert 200 can comprise a plurality of cutting edges 205 that are oriented to cut multiple surfaces simultaneously. In some aspects, the cutting insert 200 can comprise three cutting edges 205, wherein two of the three cutting edges 205 are parallel to each other, and both perpendicular to the third cutting edge 205.

Turning now to FIG. 3, a shell cutter 100 is shown with a plurality of cutting inserts 200 attached thereto in accordance with one aspect of the present disclosure. In some aspects, each cutting insert 200 can be configured to be nested within a respective cutting recess 103, and each cutting recess 103 can be sizably configured to securely receive a respective cutting insert 200, such as with an interference fit. It is envisioned that the cutting recess 103 can be structured to provide a normal force to the cutting insert 200 of sufficient magnitude to resist dislocation and/or deflection during the cutting event. In some aspects, the cutting insert 200 can be secured to the cutting recess 103 via a fastening mechanism. In some aspects, the cutting insert 200 is secured via the cutter bolt 136 received by the recess fastener hole 109 of the cutting recess 103. In some aspects, as shown, the bolt 136 can be a bolt with an internal hexagonal recess for engaging a hex key. The shell cutter 100 can be adapted to mechanically engage with a power tool. In some aspects, the shell cutter 100 can comprise a series of threads 300 which can be adapted to secure the shell cutter 100 to a power tool. In several aspects, the shell cutter 100 can be adapted to contain on the cutting face 102 one or more cutting inserts 200 which can be disposed in a substantially circular and evenly spaced arrangement around the periphery of the cutting face 102.

Turning now to FIG. 4, a shell cutter 100 in accordance with another aspect of the present disclosure is provided. The body 101 of the shell cutter 100 can be configured to perform repetitive cutting operations. The body 101 can be substantially cylindrical and define a hollow interior. The shell cutter 100 can be configured to engage with a workpiece and perform the cutting operation, wherein the cutting operation comprises cutting a circular hole defining a diameter. The diameter of the hole cut can be configured based on the diameter of the body 101 of the shell cutter 100. The cutting relief 106 can be disposed between the cutting end 104 and distal end 105 of the cutter body which can be configured to relieve heat, thermal expansion, or vibration during cutting. The cutting relief 106 can be defined as a voided area that can define a shape such as, for example and without limitation, a circular edge, a semicircular edge, or a curvilinear edge. In some aspects, the cutting relief 106, and more generally, the cutting insert 200 can comprise a shape or profile which can be configured for cutting. In an illustrative aspect, the shape of the cutting insert 200 or cutting relief 106 can be adapted to suit desired type of cut. In some aspects, the cutting insert can define a hardness which can be equal to or greater than a hardness of a workpiece (not shown). In some aspects, the cutting relief 106 can comprise a substantially curved region that is structured to provide a space between the shell cutter 100 and workpiece during a cutting event. The cutting relief 106 can be configured to promote even thermal expansion of the shell cutter 100 during the cutting operation. The cutting face 102 can be disposed on the cutting end 104 and can be formed into the body 101. The cutting face 102 can comprise one or more cutting recesses 103. Each cutting recess 103 can comprise a retention mechanism 400 and a cutting relief 106. The retention mechanism can be configured to retain a cutting insert to the cutting recess 103.

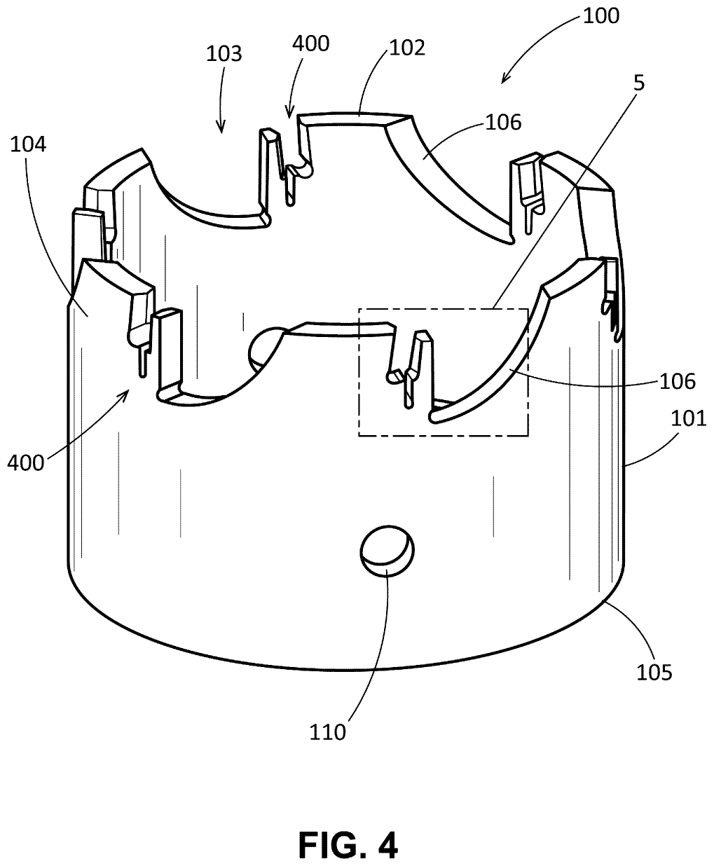

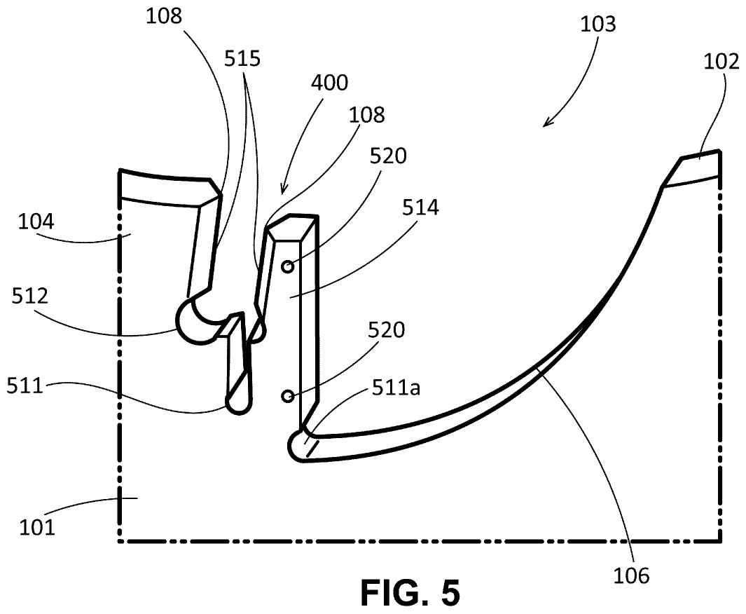

Turning now to FIG. 5, a detail view of the cutting recess 103 of the shell cutter 100 of FIG. 4 is shown. In some aspects, the cutting recess 103 can comprise the cutting relief 106 and one or more finger holes 520. The cutting relief 106 can be configured to provide chip removal and/or the kerf during a cutting operation. The cutting relief 106 can be formed in the cutting face 102 and can be curvilinear. In some aspects, the cutting relief 106 is sized to allow engagement of the cutting face 102 with a workpiece and provide a space between the cutting face 102 and the workpiece. In some aspects, the cutting recess 103 can comprise the retention mechanism 400. The retention mechanism 400 can be configured to retain the cutting insert 200. The retention mechanism 400 can be structured to securely locate the cutting insert 200 and provide quick access thereto when replacing the cutting insert 200. Further, the retention mechanism 400 can be structured to enable a more rapid replacement of the cutting insert 200 when compared to a cutting recess 103 without the retention mechanism 400. In some aspects, the retention mechanism 400 can be operable to provide an interference fit between the retention mechanism 400 and the cutting insert 200. It is envisioned that a user can quickly replace work or damaged cutting inserts 200 in between cutting operations by way of manipulating the retention mechanism 400.

Continuing with FIG. 5, the retention mechanism 400 can comprise any of a fulcrum 511, a cam receptacle 512, locating features 108, and a flexure 514. The flexure 514 can extend upwardly and axially away from the body 101. The combination of one or more of these features can be operable to provide a retaining force, wherein the retaining force is of sufficient magnitude to retain the cutting insert 200 during cutting. In some aspects, the retention mechanism 400 can be configured to proportion the magnitude of the retaining force based on the magnitude of a reaction force generated during cutting. In some aspects, the retention mechanism 400 can be configured to increase the magnitude of the retaining force when the reaction force from cutting is increased. In some aspects, the retention mechanism 400 can be operable to provide an interference fit between the retention mechanism and the cutting insert 200. In some aspects, the retention mechanism can be operable to provide a normal force to the cutting insert 200.

The retention mechanism 400 can comprise the fulcrum 511, wherein the fulcrum is disposed in the body 101. In some aspects, the fulcrum 511 can be configured to allow semi-rigid mechanical communication between the flexure 514 and the retention mechanism 400. The fulcrum 511 can be a second-class lever fulcrum wherein the flexure 514 is the main structure of the lever. In some aspects, the fulcrum 511 can be configured to enable the retention mechanism 400 to flex. In some aspects, the retention mechanism can comprise one or more fulcrums 511. In some aspects, the retention mechanism 400 can comprise a second fulcrum 511a. The second fulcrum 511a can be defined in a side of the flexure 514 opposite the fulcrum 511. The second fulcrum 511a can be configured to allow the flexure 514 to flex. In various aspects, the second fulcrum 511a can be configured to act with the fulcrum 511 and allow the flexure 514 to articulate. The fulcrum 511 and/or the second fulcrum 511a can be defined as a voided area in the cutting face 102. The amount of voided area in the fulcrum 511 and/or the second fulcrum 511acan be sizably configured based on the elasticity of the cutting face 102 and desired elasticity of the flexure 514. In some aspects, the fulcrum 511 and/or the second fulcrum 511a can define a semicircular cutout. More generally, the fulcrum 511 and/or the second fulcrum 511a can define a substantially curved cutout. In some aspects, the retention mechanism 400 can comprise a cam receptacle 512. The cam receptacle 512 can be a region whose area is adapted for mechanical communication with a tool. In such an aspect, the cam receptacle 512 is structured to engage with the tool, and while so engaged, generate an opening force to the retention mechanism 400. In some aspects, the cam receptacle 512 can be configured to release the holding force provided by the flexure 514. In some aspects, the cam receptacle is operable to release a cutting insert 200. In certain aspects, the cam receptacle 512 can define a substantially circular void in the body 101.

In some aspects, the retention mechanism 400 can comprise one or more locating features 108. The locating features 108 can be formed on a clamping face 515 and/or the flexure 514. The locating features 108 can comprise a profile formed on a face of the retention mechanism 400. In some aspects, the locating features 108 are configured to engage with the cutting insert 200. The engagement between the locating feature 108 and the cutting insert 200 can be any of an interference fit, a location fit, a profile fit, or a snap fit. In some aspects, the locating feature 108 can have a positive profile such as a male feature and the cutting insert 200 can have an opposite negative profile, such as a female feature wherein the male feature of the locating feature 108 can be configured to be received by the female feature of the cutting insert 200. For example, the flexure 514 can utilize the elasticity of the body 101 of the shell cutter 100 to provide a force which can act on the cutting insert 200 and secure the cutting insert 200 against the shell cutter 100. In some aspects, the shell cutter 100 can comprise the finger hole 520. In various aspects, the shell cutter 100 can comprise one or more finger holes 520. The finger holes 520 can define a through hole which can extend through a portion of the shell cutter 100. The finger holes 520 can be defined proximal to the fulcrum 511 and configured to transfer a force to the shell cutter 100, as discussed below. In some aspects, the finger holes 520 can partially extend through the shell cutter 100.

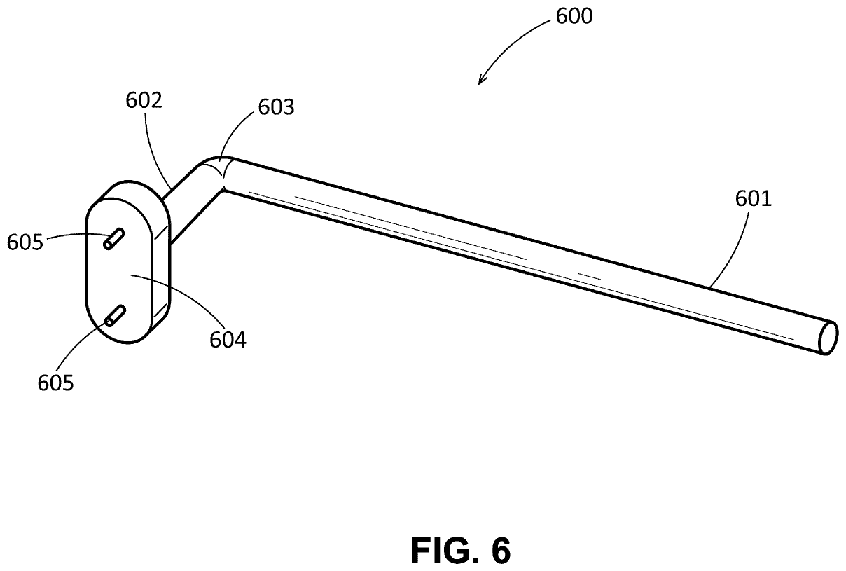

Turning now to FIG. 6, a perspective view of a cam tool 600 in accordance with one aspect of the present disclosure is provided. As shown, the cam tool 600 can comprise a lever-like structure which can be structured to be operated by a user. In some aspects, the cam tool 600 can comprise a first cam tool arm 601 defined by an elongated member extending axially. The first cam tool arm 601 can be in coupled with a second cam tool arm 602 via a joint 603. In some aspects, the first cam tool arm 601 can have a length greater than the second cam tool arm 602 length and can be engaged therewith at a substantially 90-degree angle via the joint 603. It is envisioned that the cam tool 600 can be constructed of a substantially rigid material, such as steel or another metalloid. The cam tool 600 can be structured to resist deformation under a bending stress. In some aspects, the second cam tool arm 602 can be in coupled with a cam tool face 604. The cam tool face 604 can have a shape that can be configured to be received by the cam receptacle 512 (shown in FIG. 5) disposed on the retention mechanism 400. In some aspects, the cam tool face 604 can comprise a non-circular profile or a cammed profile. In some aspects, the cam tool face 604 can include one or more cam fingers 605. The cam fingers 605 can be adapted to engage with and interlock with retention mechanism 400 to encourage the cam tool 600 to engage at a specified position. In some aspects, the cam tool 600 can mechanically couple with the shell cutter 100 by, for example, engaging the cam fingers 605 with the finger holes 520 of the shell cutter 100. In some aspects, the cam tool 600 can be configured to pivot about the cam receptacle 512. In some aspects, the cam tool 600 can be configured to pivot about the finger holes 520.

In some aspects, the cam tool 600 can be configured to, while engaged with the retention mechanism 400, release the holding force provided therefrom. In some aspects, the cam tool 600 can be configured to be rotated while engaged with the retention mechanism 400. For example, and without limitation, the cam tool 600 can be engaged with the retention mechanism 400 by way of interlocking the cam tool face 604 with the cam receptacle 512 of the retention mechanism 400. In such an example, the profile of the cam tool face 604 and cam receptacle 512 can be configured such that, when the cam tool 600 is rotated, the holding force of the retention mechanism 400 that acts on the cutting insert 200 can be discontinued or interrupted. It is envisioned that the cam tool 600 can be used during a cutting insert replacement event. In an exemplary aspect, the cam tool 600 can be operable to provide a separation force by rotating the cammed cam tool face 604 in the cam receptacle 512. In a similar manner, the cam tool 600 can provide a separation force by interlocking the cam fingers 605 with the finger holes 520. In some aspects, the cam tool 600 can engage with the retention mechanism 400 and while so engaged, urge the retention mechanism to shift from a first position to a second position. The retention mechanism 400 can return to the first position after engagement between the cam tool 600 and retention mechanism 400 is discontinued.

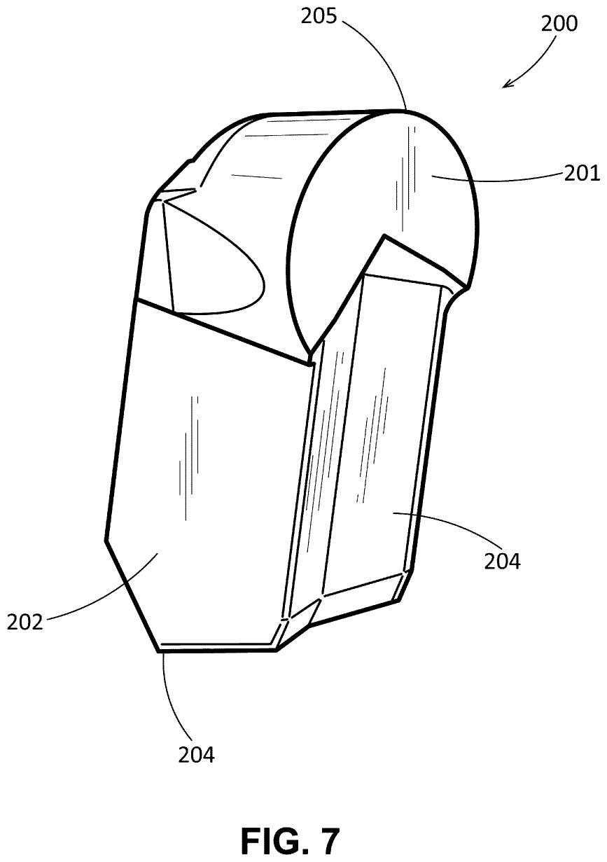

Turning now to FIG. 7, a perspective view of another aspect of a cutting insert 200 is provided in accordance with another aspect of the disclosure. In one aspect, the cutting insert 200 can be retained by the retention mechanism 400. In some aspects, the cutting insert 200 can comprise an insert base 202 that is sizably configured to engage with the shell cutter 100. In some aspects, the cutting insert 200 is configured to be engaged by the flexure 514 (shown in FIG. 5) and acted on by a normal force provided therefrom. In some aspects, the cutting insert 200 can be configured to be located by the locating features 108, and more generally, the cutting recess 103 of the present disclose. In some aspects, the cutting insert 200 can be configured to perform work to a workpiece such as, for example and without limitation, performing a cutting operation on a workpiece. In some aspects, the cutting insert 200 can be composed of any material suitable for cutting a workpiece. For example and without limitation, the cutting insert 200 can be composed of carbide, tungsten carbide, high speed steel, ceramic, ceramic-metal composite, coated carbides, cubic boron nitride, sintered metallic material, sintered powder metal, diamond, sintered powdered metal, polycrystalline diamond, and nitrated alloys. In some aspects, the cutting insert 200 can be mechanically coupled to the retention mechanism 400 and forcibly retained thereon. In some aspects the cutting insert 200 can comprise a cutting face 201 disposed on the cutting insert 200. In some aspects, the cutting face 201 can comprise a curvilinear surface and define a radius. In some aspects, the cutting face 201 can define an arc. The cutting face 201 can have a frontal area which can be greater than the frontal area of the cutting insert 200 which can create a kerf.

The cutting face 201 can be configured in a variety of shapes, such as and without limitation, a button insert, a tri cutter, a straight edge, a parting edge, a rectilinear edge, or any such shape used by machinist tools. It is envisioned that the shape of the cutting face 201 will determine the profile of the cut work surface. In some aspects, the cutting edge 205 can be disposed about the perimeter of the cutting face 201 of the cutting insert 200. In some aspects, the cutting edge 205 can be configured to engage the workpiece at an angle sufficient to create a cutting shear force. In some aspects, the cutting face 201 can be configured to define a positive rake angle between the cutting face 201 and a workpiece. In some aspects, the cutting insert 200 can comprise one or more insert locating features 204 which can be configured to interlock with one or more locating features 108 of the shell cutter 100. In some aspects, the insert locating feature 204 can be a nonlinear surface. In some aspects, the insert locating feature 204 can be a V-shaped groove. In some aspects the insert locating feature 204 can be a male/female feature which can be received by an opposite male/female feature disposed on the shell cutter 100. In some aspects, the insert locating feature 204 can be operable to substantially center the cutting insert 200 within the cutting recess 103.

Continuing with FIG. 7, in some aspects the insert locating feature 204 can be configured to couple the cutting insert 200 and the retention mechanism 400. In several aspects, the insert locating feature 204 can be configured to securely engage with the locating feature 108 of the retention mechanism 400, and while engaged therewith, substantially reduce the relative motion in one or more directions between the cutting insert 200 and the retention mechanism 400. In some aspects, the cutting insert 200 can be configured to, when engaged with the locating feature 108, define a central location and retain the cutting insert 200 at such central location. In some aspects, the cutting insert 200 can comprise a female feature and the locating feature 108 can comprise a male feature wherein the male feature of the locating feature 108 can be configured to be received by the female feature of the insert locating feature 204. In some aspects, the cutting insert 200 can define a substantially V-shaped rearward surface.

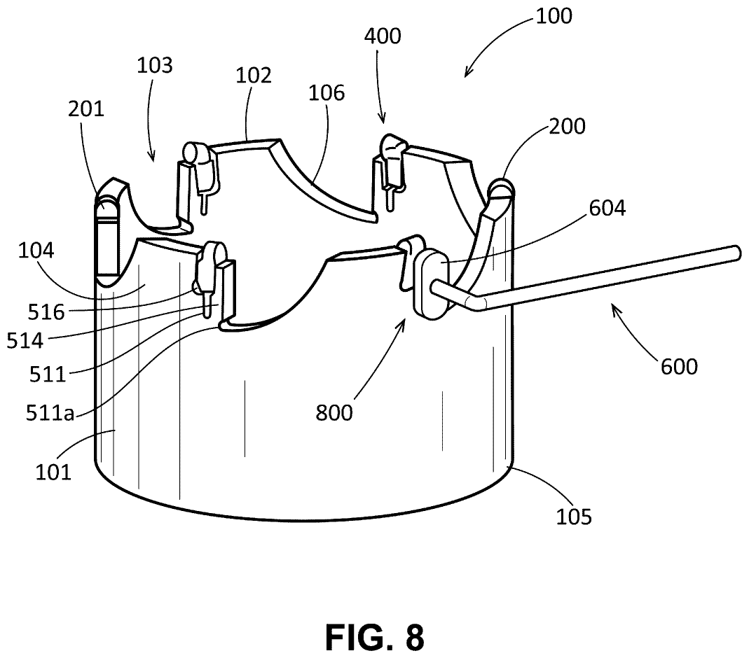

Turning now to FIG. 8, shown is a frontal perspective view of the shell cutter 100 of FIG. 4 and with a plurality of the cutting inserts 200 of FIG. 7 disposed in a plurality of the cutting recess 103 of FIG. 4, with the shell cutter 100 in engagement with the cam tool 600 of FIG. 6 in accordance with one aspect of the present disclosure. As shown, the combination of the above-mentioned elements forms a cam action 800. In some aspects, the cam action 800 can release the cutting insert 200. In some aspects, the cam action 800 can be used during a cutting insert 200 replacement event. In several aspects, the cam tool 600 can be engaged with one or more portions of the shell cutter 100. In such aspects, the cam tool 600 is operable to be used during a cutting insert replacement event. The cam tool 600 can engage with the retention mechanism 400, and more generally the shell cutter 100 at, for example, the cam receptacle 512 and/or the finger holes 520. For example, the cam tool 600 can be used to assist in the replacement of used, dulled, or damaged cutting inserts 200. In such an example, the cutting inserts 200 located on the shell cutter 100 are damaged from, for example, multiple cutting events, abrasion, impact, or any similar damaging scenario. Without the use of the cam tool 600, the retention force acting on the cutting inserts 200 via the retention mechanism 400 would increase the difficulty of flexing the flexure 514 to replace the cutting inserts 200. The cam tool 600 can be inserted into the cam receptacle 512 and rotated. When rotated, the cammed shape of the cam tool face 604 is structured to provide a separatory force to the flexure 514 and temporarily discontinue the holding force allowing the cutting insert 200 to be removed and replaced with a new cutting insert 200. It is envisioned that the use of a cam tool 600 during a cutting insert 200 replacement event will increase the rapidity at which such an event occurs when compared to cutting insert 200 replacement events by other mechanism.

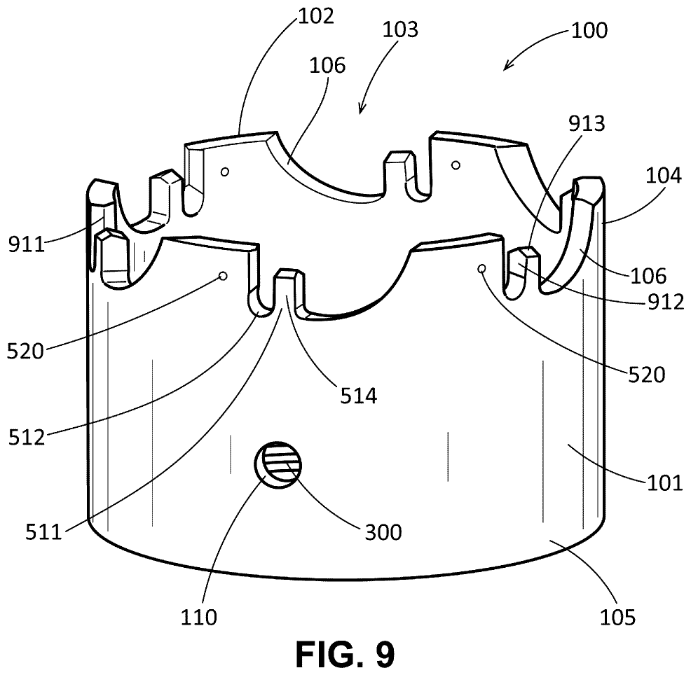

Turning now to FIG. 9, a frontal perspective view of an embodiment of the shell cutter 100 in accordance with another aspect of the present disclosure is provided. The shell cutter 100 can be a cutting tool, such as a rotary tool. In some aspects, the shell cutter 100 can be a pipe coupon tool which can be configured to cut and retain pipe coupons. The shell cutter 100 can comprise a body 101. The body 101 of the shell cutter 100 can include the cutting recess 103. In some aspects, the cutting recess 103 can be configured to engage with a work surface, and more specifically, can be configured to cut the work surface. The plurality of cutting recesses 103 disposed about the periphery of the cutting face 102. Each cutting recess 103 can comprise a rearward locating feature 911 which can be configured to engage with the cutting insert 200. In some aspects, the rearward locating feature 911 can comprise a nonlinear profile which can be structured to engage with a similar nonlinear profile on the cutting insert 200. In some aspects, the nonlinear profile can be substantially V-shaped. In some aspects, the nonlinear profile can define a substantially V-shaped forward surface.

In some aspects, the locating feature 108 can be operable to fixedly locate the cutting insert 200 thereon. In some aspects, the locating feature 108 can be operable to retain the cutting insert 200 at a singular position during, for example, the cutting operation. Further included on the cutting recess 103 is a frontal locating feature 912. In some aspects, the frontal locating feature 912 can be opposite to the rearward locating feature 911. In some aspects, one or both of the frontal locating feature 912 and rearward locating feature 911 can extend axially relative to the body 101. In some aspects, the frontal locating feature 912 can be configured to mechanically engage with the cutting insert 200. In some aspects, both the frontal locating feature 912 and rearward locating feature 911 can engage with the cutting insert 200. In some aspects, the combined engagement of the frontal locating feature 912 and rearward locating feature 911 can produce a clamping force of sufficient magnitude to reduce the relative motion between the cutting insert 200 and the shell cutter 100 to essentially zero. In several aspects, the frontal locating feature can comprise a superjacent surface comprising a top locating feature 913. The top locating feature 913 can be configured to engage with a surface of the cutting insert 200. In some aspects, the combination of the top locating feature 913 and the rearward locating feature 911 and/or the frontal locating feature 912 can constrain and locate the cutting insert 200 relative to the body 101. In some aspects, the shell cutter 100 can comprise the fulcrum 511 about which the frontal locating feature 912 can pivot. In several aspects, the cutting insert 200 can be restrained by a retentive force generated by the elasticity of the body 101 of the shell cutter 100.

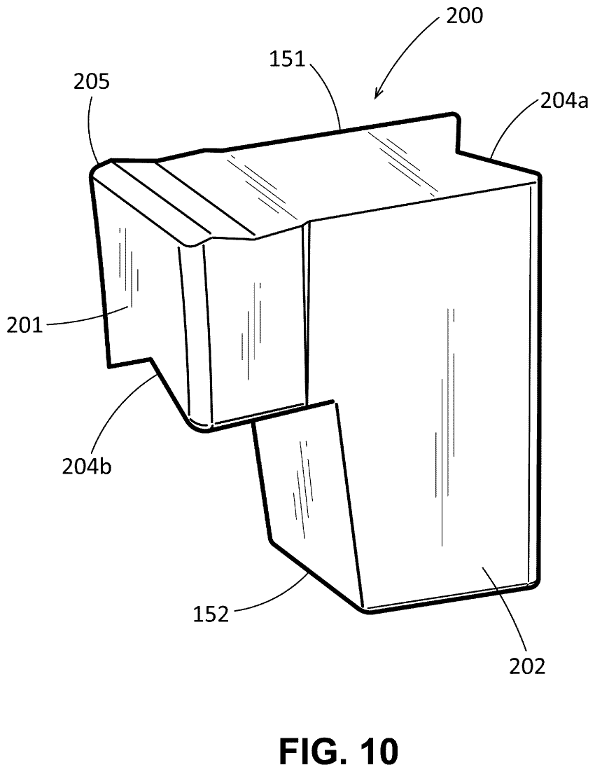

Turning now to FIG. 10, a side perspective view of yet another aspect of a cutting insert 200 in accordance with another aspect of the present disclosure is shown. In some aspects, the cutting insert 200 can comprise the insert base 202 which can be configured to mechanically engage with a shell cutter 100. In some aspects, the cutting insert 200 can define a cutting insert proximal end 151 and a cutting insert distal end 152 opposite the cutting insert proximal end 151. In several aspects, the cutting insert 200 can be configured to engage with a work surface and, for example, perform a sheering work or machining to the work. In some aspects, the cutting insert 200 can include at least one cutting insert locating feature 204. In several aspects, the flexure cutting insert locating features 204 are configured to releasably interlock with a locating feature of the shell cutter 100. It is envisioned that the cutting insert locating feature 204 can comprise a nonlinear profile which can be adapted to match with an opposite nonlinear profile of a surface of the shell cutter 100. In some aspects, the cutting insert locating feature 204 is structured to securely locate the cutting insert 200. In some aspects, the cutting insert 200 can comprise a pair of cutting insert locating features 204, wherein the pair of cutting insert locating features 204 are disposed perpendicular to each other. For example, the insert base 202 of the cutting insert 200 can comprise a first cutting insert locating feature 204a extending vertically and a second cutting insert locating feature 204b extending laterally. In such an exemplary aspect, the first cutting insert locating feature 204a can be operable to constrain the cutting insert 200 in a first direction and the second cutting insert locating feature 204b can be operable to constrain the cutting insert 200 in a second direction, which can result in minimized relative motion of the cutting insert 200. In addition, the cutting insert distal end 152 can be forcibly engaged with the insert base 202 which can constrain relative motion in a third direction. More generally, in some aspects, cutting insert locating features 204 can constrain the motion of the cutting insert 200 in one or more directions.

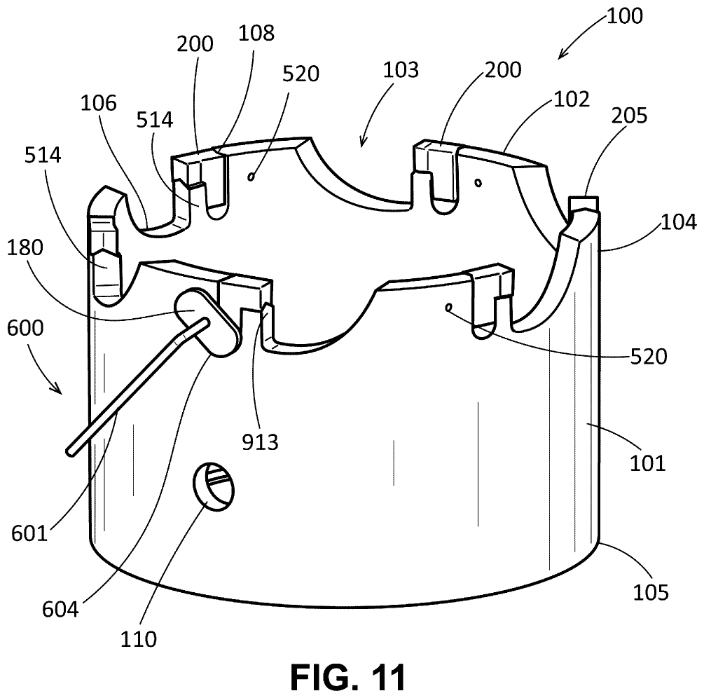

Turning now to FIG. 11, an elevated perspective view of the shell cutter 100 of FIG. 9 with a plurality of the cutting insert 200 of FIG. 10, with the cutting tool in engagement with the cam tool 600 of FIG. 6 is shown. In some aspects, the shell cutter 100 can comprise a rotary cutting tool which can be configured to perform work on a work surface, for example, perform a cutting operation on a pipe. The shell cutter 100 can comprise the body 101 defining cutting face 102 disposed on the cutting end 104 thereof. In some aspects, the cutting face 102 can comprise the plurality of equidistantly spaced cutting recesses 103. In some aspects, the cutting recesses 103 can be configured to securely contain the cutting insert 200. The cutting insert 200 can comprise the cutting edge 205 which is structured to engage with and cut a work surface. In some aspects, the cutting insert 200 can be engage with the locating feature 108 of the cutting recess 103 and a top locating feature 913 of the cutting recess 103.

In some aspects, the shell cutter 100 can be configured to allow quick removal of the cutting inserts 200 from the shell cutter 100. In some aspects, the shell cutter 100 can include a plurality of cutting inserts 200. Further, the shell cutter 100 can be customizable based on the type of cutting insert 200 installed. For example, the shell cutter 100 can be equipped with a first cutting insert 200 having a first cutting profile for use during a first cutting operation and then subsequently equipped with a second cutting insert 200 having a second cutting profile for use during a second cutting operation. It is envisioned that the cutting inserts 200 can resemble cutting inserts used with machine tools and can be similarly operable and customizable based on the requirements of certain jobs.

Continuing with FIG. 11 as shown, the cam tool 600 can be in mechanical communication with the shell cutter 100. In some aspects, the cam tool 600 is operable to enable a single tool and rapid replacement of the cutting inserts 200. The cam tool 600 can be engaged with the shell cutter 100, for example, via a cam tool fulcrum point 180. In some aspects, the cam tool 600 can be configured to pivot about the cam tool fulcrum point 180. In some aspects, the cam tool 600 can simultaneously be pivotally coupled with the cam tool fulcrum point 180 and in contact with the cutting insert distal end 152. In such aspects, the cam tool can be operable to urge the cutting insert 200 upwardly to be removed from the shell cutter 100. For example and without limitation, the cam fingers 605 (shown in FIG. 6) can be engaged with and rotated about the cam tool fulcrum point 180. During such event, the cam tool 600 can provide an upward force on the cutting insert 200 and encourage the cutting insert 200 to release from the shell cutter 100.

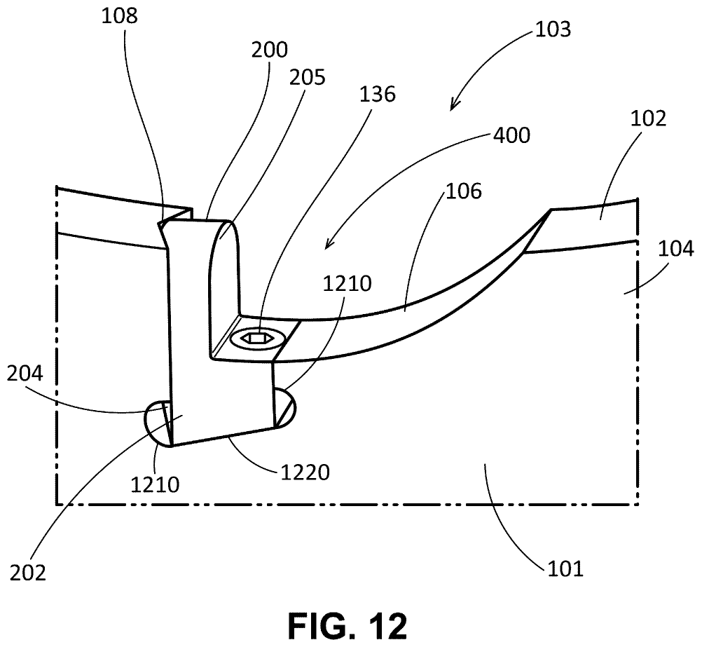

Turning now to FIG. 12, an isometric view of yet another aspect of a cutting recess 103 and cutting insert 200 in accordance with another aspect of the present disclosure is shown. In some aspects the shell cutter 100 comprises the plurality of cutting inserts 200 secured to the cutting recess 103 via an interference fit provided by the retention mechanism 400. In some aspects, the shell cutter can comprise the cutting insert 200 which can be received by the cutting recess 103. In some aspects, the cutting recess 103 can comprise the locating feature 108 which can be structured to define a central position. The cutting insert 200 can comprise the insert locating feature 204 which can comprise a feature structured to be received by the locating feature 108 of the cutting recess 103. For example, the cutting insert 200 can be fixedly located and retained at a defined position identified by the locating feature 108. In some aspects, the cutting insert 200 can include the cutter bolt 136 which can be configured to retain the cutting insert 200 to the shell cutter 100. As shown, the cutting recess 103 can define a pair of side cutouts 1210 on either side of where the insert base 202 contacts the cutting recess 103. The side cutouts 1210 can be formed by necessity, in some aspects, during a milling operation, where a milling cutter with a circular cutting profile mills a flat bottom edge 1220 of the cutting recess 103 where the insert base 202 engages.

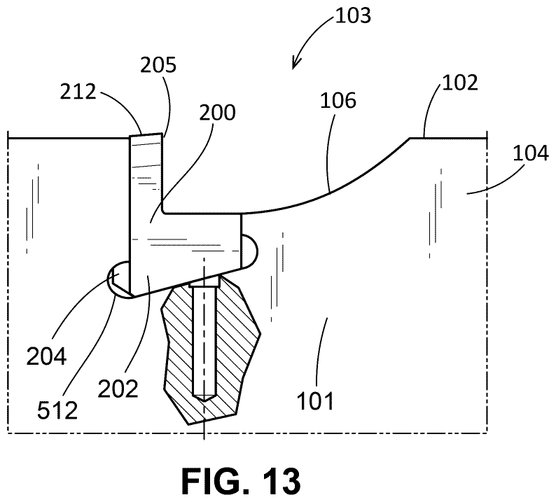

FIG. 13 is a frontal perspective view of the cutting recess and cutting insert of FIG. 12. In some aspects, the cutting recess 103 can comprise the cutting face 102 which can be disposed on the cutting end 104 of the shell cutter 100. The cutting recess 103 can comprise the cutting insert 200. The cutting insert 200 can be disposed, for example, opposite to the cutting relief 106. In some aspects, the cutting insert 200 can be retained in the cutting recess 103 by the fastener (shown in FIG. 12), such as cutter bolt 136. In some aspects, the cutting insert 200 can be retained by one or more fasteners (shown in FIG. 12). The fastener (shown in FIG. 12) can be any mechanism suitable to provide sufficient retentive force to retain the cutting insert 200 to the cutting recess 103. Some examples of fasteners can include but are not limited to machine screws, set screws, grub screws, Allen head screws or bolts, torx head bolts, or any threaded fastener. The insert base 202 of the cutting insert 200 can be forcibly retained to the cutting recess by the fastener (shown in FIG. 12). In some aspects, the fastener (depicted in FIG. 12) can be configured to securably release the cutting insert 200. In some aspects, In some aspects, the fasteners and optionally the cutting insert 200 can be parallel to the body 101 and more generally, the shell cutter 100. In some aspects, the cutting insert 200 and/or the fastener (shown in FIG. 12) can be substantially parallel to the axis 111 (shown in FIG. 1). In some aspects, the insert base 202 can be disposed proximal to the flexure 511 (shown in FIG. 5). In some aspects, the cutting insert 200 can define the insert locating feature 204. The insert locating feature 204 of the cutting insert 200 can be configured to engage with the locating feature (shown in FIG. 12) of the cutting recess 103.

In some aspects, the cutting inset 200 can comprise the cutting edge 205. The cutting edge 205 can be disposed on the cutting insert 200 opposite to the insert locating feature 204. In some aspects, the cutting edge 205 can define an edge which can be sharpened or angled. The cutting edge 205 can be configured to shear or cut a workpiece when engaged therewith. In some aspects, the cutting edge 205 can define a substantially curvilinear profile. In other aspects, the cutting edge 205 can define an angular profile. In example aspects, the cutting edge 205 can comprise a substantially arched or semicircular profile. In other example aspects, the cutting edge 205 can comprise a profile which can define one or more continuous diverging lines. In one example aspects, the cutting edge 205 can comprise a profile defined by a portion of a hexagon. The cutting edge 205 of the cutting insert can be configured based on the desired profile to be cut. The cutting edge 205 can extend past the cutting edge 102 of the cutting recess 103. In some aspects, the cutting edge 205 can extend past the width of the cutter body 101. In some aspects, the cutting edge 205, and more generally, the cutting insert 200 can comprise an area which can be greater than an area of a cross section of the cutting recess 103. In some aspects, the cutting edge 205 can comprise a taper 212. The taper 212 can be defined on a top most portion of the cutting insert 200 opposite to the insert base 202. In some aspects, the taper 212 can initiate at the cutting edge 102 and can terminate at the cutting edge 205. The taper 212 can be configured to extend the cross section of the cutting recess 102 to the cross section of the cutting insert 200. In some aspects, the cutting insert 200 can be a monolithic unit. In some aspects, the cutting edge 205 can be defined on a portion of the cutting insert 200. In some aspects, the cutting insert 200 can be sharpened. The sharpened cutting insert 200 can form the cutting edge 205. More generally, in some aspects, the cutting insert 200 can be formed into any suitable shape for cutting. Further, the cutting insert 200 can be sharpened to form or reform the cutting edge 205 on a portion thereof.

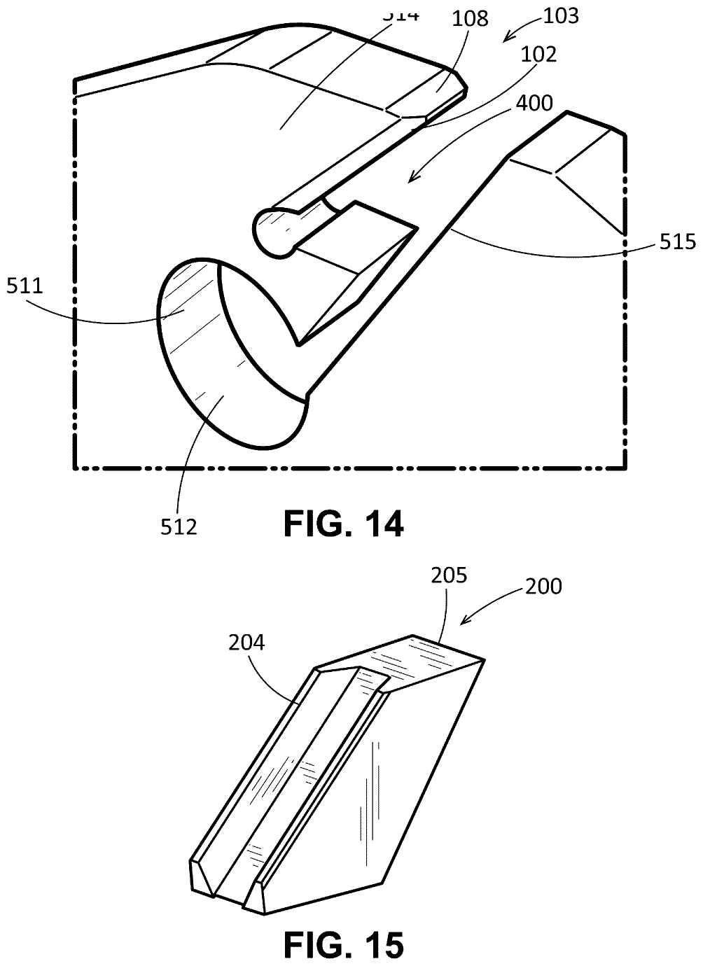

Turning now to FIG. 14, an alternative aspect of the cutting recess 103 is shown in accordance with one aspect of the current disclosure. In some aspects, the cutting recess 103 can comprise the retention mechanism 400. In some aspects, the retention mechanism 400 can comprise any of the fulcrum 511, the cam receptacle 512, the locating feature 108, the flexure 514, and the clamping face 515. In some aspects, the fulcrum 511 and the cam receptacle 512 are the same feature. In some aspects, the combination of one or more of the foregoing features is operable to retain the cutting insert 200 to the cutting recess 103. In various aspects, the fulcrum 511 can be structured to bias the flexure 514. For example, the fulcrum 511 can be configured to bias the flexure 514 against the cutting insert 200. In some aspects, the retention mechanism 400 is operable to utilize the elasticity of the body 101 to retain the cutting insert 200. In some aspects, the flexure 514 can be canted towards the clamping face 515 at an angle between 90 degrees and zero. In some aspects, the flexure 514 can be canted at an acute angle relative to the work surface. In some aspects, the angle of the flexure 514 can be adapted or biased to direct a normal force from a cutting event towards the shell cutter 100. More specifically, the angle of the flexure 514 can be configured to direct a normal force developed from the interaction between the shell cutter 100 and the workpiece towards the cutting insert 200 which can be of sufficient magnitude to forcibly retain the shell cutter against the retention mechanism 400. In various aspects, the flexure 514 can be biased towards the cutting insert 200. The biased flexure 514 can be configured to provide the normal force. In some aspects, the retention mechanism 400 is positioned such that, while engaged with a workpiece, the normal force generated from the engagement increases the retentive force provided by the retention mechanism 400. More generally, the retention mechanism 400 can be operable to increase the retentive force generated during a cutting event. Such a configuration can be structured to self-tighten.

Turning now to FIG. 15, an alternative aspect of the cutting insert 200 is shown and described. The cutting insert 200 can comprise one or more cutting edges 205 which can be configured to engage with a work surface and remove material during a cutting event. In some aspects, the cutting insert 200 can comprise a plurality of cutting edges 205 which can be configured to engage a work surface at more than one lateral edge. In some aspects the cutting insert 200 can comprise the cutting insert locating feature 204 which can be mechanically coupled to the locating feature 108 of a cutting recess.

A method of using the shell cutter 100 can comprise obtaining the shell cutter 100, which can comprise the body 101 and the cutting face 102 or the cutting recess 103. The shell cutter 100 can further comprise one or more cutting inserts 200. The method can comprise affixing one or more of the cutting inserts 200 to the shell cutter 100. In some aspects, the method can comprise replacing a cutting insert 200 by hand. In some aspects, the method can comprise replacing the cutting insert 200 (i.e., assembling and forming anew the cutting insert 200) before each use of the shell cutter 100. The method can comprise receiving the cutting insert 200 within the cutting recess 103 of the shell cutter body 101 upon one of a cutting insert 200 replacement event or cutting event. In some aspects, the method can comprise replacing a first cutting insert 200 with a second cutting insert 200. In some aspects, the first cutting insert 200 can be configured to define a first shape and the second cutting insert 200 can be configured to define a second shape, wherein the first and second cutting insert shapes are dissimilar. In such an aspect, the shape of the cutting insert 200 can be modified based on the desired cut or profile of cut. In other aspects, the method can comprise replacing the first cutting insert 200 with a second cutting insert 200. In some aspects, the first cutting insert 200 can be configured with a first hardness and the second cutting insert can be configured with a second hardness wherein the first and second hardnesses are dissimilar. In such an aspect, the cutting insert 200 can, for example, be replaced with different cutting inserts 200 based on the type of material to be cut.

In some aspects, a method of using the shell cutter 100 can comprise replacing the cutting insert 200. In some aspects, such method can comprise manipulating the cutter bolt 136 on the cutting insert 200. In some aspects, the method can comprise removing a first cutter bolt 136 and releasing the cutting insert 200. In some aspects, the method can comprise mounting or securing a new cutting aspect 200 with the previously removed bolt 136. In other aspects, the method can comprise providing a new cutter bolt 136 to secure the new cutting insert 200. In some aspects, the method can comprise reusing the cutter bolt 136 during the replacement of the cutting insert 200. In some aspects, the method can comprise manipulating a retention mechanism 400. In some aspects, the method can comprise using a tool, for example and without limitation, a cam tool 600 to release a cutting insert 200. For example, a method of use can comprise obtaining a shell cutter 100 having one or cutting inserts 200, obtaining a cam tool 600, engaging the cam tool 600 with the shell cutter 100, and replacing the cutting inserts 200. In some aspects, the cam tool 600 can be rotated with respect to the shell cutter 100 while engaged therewith. The method can comprise using the cam tool 600 to expand, extend, or open the retention mechanism 400 to release the cutting insert 200. In some aspects, the cam tool 600 is operable to temporarily discontinue a holding force provided by the retention mechanism 400 acting on the cutting insert 200. In some aspects, the method can comprise re-using the cam tool 600 or repeating the process to replace multiple cutting inserts 200. In some aspects, the method can include using the cam tool 600 to apply a force directly to the cutting insert 200. In some aspects, the method can comprise using the cam tool 600 to impinge and/or pry the cutting insert 200 from the retention mechanism 400. In some aspects, the method can comprise using the cam tool 600 to elastically deform the retention mechanism 400. In some aspects, the method can comprise articulating the cam tool 600. Further, and in some aspects, the method can comprise rotating the cam tool 600 by way of applying a force to the cam tool 600.

In some aspects, the method can comprise providing the cutter bolt 136. In some aspects, the method can comprise selectively engaging with the cutter bolt 136. In some aspects, the method can comprise engaging the cutter bolt 136 with a tool (not shown). For some methods, the cutter bolt 136 can be configured to engage with, for example and without limitation, a screwdriver, an Allen wrench, a socket wrench, a torx bit, a rivet, or any mechanical tool. In some methods, the cutter bolt 136 can be selectively loosened or tightened. In some methods, the cutter bolt 136 can be configured to retain the cutting insert 200 in the cutting recess 103. In some methods, the cutter bolt 136 can be configured to modulate a holding force on the cutting insert 200. In some methods, the cutter bolt 136 can be loosened to release the cutting insert 200 from the cutting recess 103. In some methods, the first cutting insert 200 can be replaced with the second cutting insert 200. In some methods, the first cutter bolt 136 can be replaced with a second cutter bolt 136. For example, the first cutter bolt 136 can be replaced if it experiences stress, deformation, shear, wear, or any like mechanical deformation. In some methods, thread locker (not shown) can be applied to the cutter bolt 136. In some aspects, the cutting insert 200 can be sharpened, ground, polished or repaired.

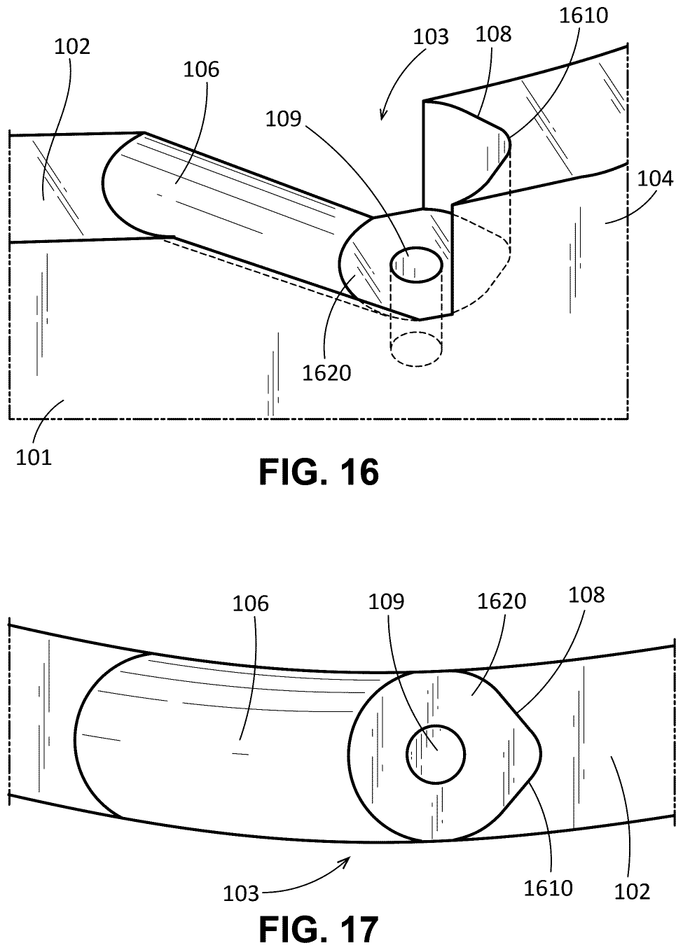

FIG. 16 shows a cutting recess 103 in accordance with another aspect of the current disclosure. As shown, the cutting recess 103 defines the cutting relief 106 and the locating feature 108. In the current aspect, the cutting recess 103 can be formed with milling operations using milling cutters that all extend parallel to the axis 111 (shown in FIG. 1). This allows for easier and more cost-effective formation of the cutting recesses 103 in the shell cutter 100. A first milling operation forms the cutting relief 106 by milling in an axial direction while the milling cutter translates along circumferentially along the cutting face 102 until the milling cutter stops at a base 1620 of the cutting relief 106, after which it is removed in an axial direction, thereby forming locating feature 108. In the current aspect, the cutting relief 106 defines a concave profile extending from the cutting face 102 to the base 1620, and the base 1620 can be substantially or partially circular, which can match the shape of the cutting end of the milling cutter. An additional milling cutter with a smaller diameter can thereafter move axially downward to form the recess fastener hole 109 in the base 1620. The additional milling cutter or a separate milling cutter can thereafter form an anti-rotation feature 1610 in the locating feature 108 by moving axially downward into the cutting face 102.

As shown in FIG. 17, the recess fastener hole 109 can be formed in a center of the base 1620. Further, the anti-rotation feature 1610 can be defined in the locating feature 108 towards a midpoint of the locating feature 108 as a portion with a smaller radius of curvature extending circumferentially from the locating feature 108 and from the base 1620.

As shown in FIG. 19, a cutting insert 200 can be mounted in the cutting recess 103 as shown. The cutting insert 200 can define the locating feature 108 that is shaped complimentary to the locating feature 108, and in particular to the anti-rotation feature 1610, to prevent rotation of the cutting insert 200 during a cutting operation. The cutting insert can define a circular cutting edge 205 with a concave cutting face 201, and the insert base 202 can be flush with the base 1620 of the cutting recess 103. The cutting insert 200 can also define the bolt portion 121 therethrough to allow a fastener, such as cutter bolt 136, to extend through the bolt portion 121 into the recess fastener hole 109 to hold the cutting insert 200 in the cutting recess 103.

Another aspect of the cutting recess 103 is shown in FIG. 19. In the current aspect, no anti-rotation feature 1610 is present. Instead, the recess fastener hole 109 can be offset from a center of the base 1620. The cutting insert 200, which can also define a bolt portion 121 that is similar offset relative to the insert base 202, is thereby prevented from rotating by the combination of the recess fastener hole 109 and the locating feature 108. In other aspects, the recess fastener hole 109 can be offset in other directions relative to the center of the base 1620 with similar effect.

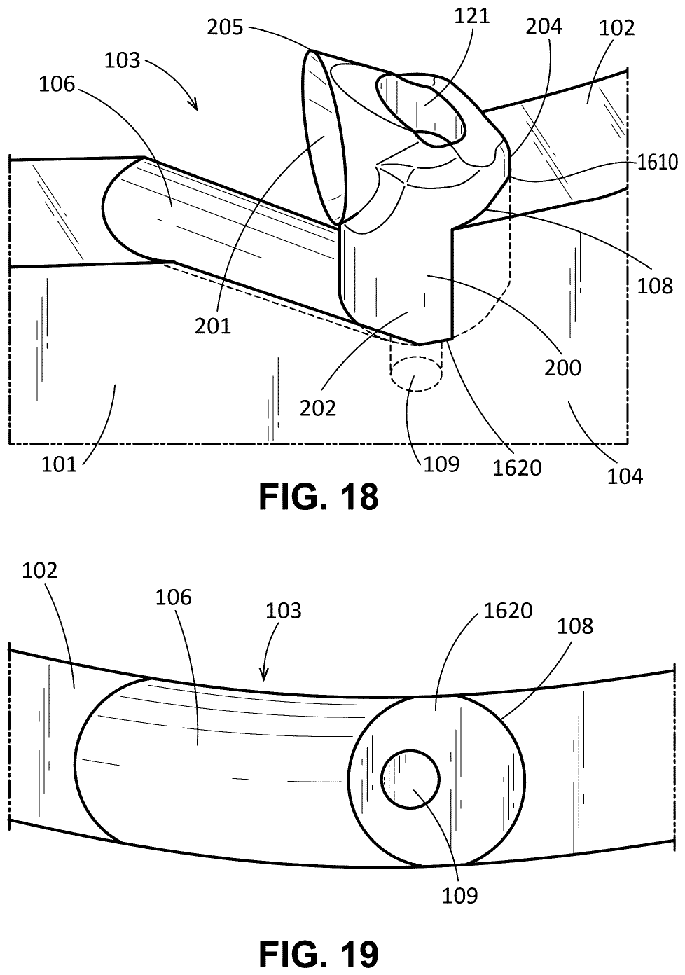

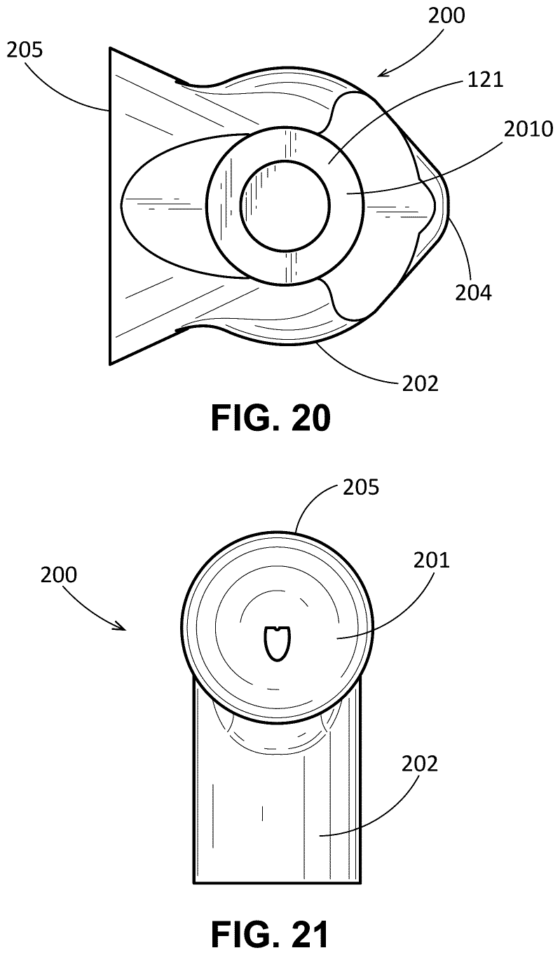

FIGS. 20 and 21 show the cutting insert 200 of FIG. 18. As shown, the cutting edge 205 can define a circle around the concave cutting face 201. Further, the bolt portion 121 can define a countersink or counterbore 2010 that can engage a bolt head of the cutter bolt 136 or other fastener to hold the cutting insert 200 in place. In addition, the locating feature 204 of the cutting insert 200 is shown in FIG. 20 to have a complementary shape to the anti-rotation feature 1610 of FIG. 16.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A rotary cutting tool comprising:
a substantially cylindrical body defining a center axis extending therethrough, the body comprising a cutting face;
a cutting insert; and
a cutting recess defined in the cutting face, the cutting recess extending axially into the substantially cylindrical body from the cutting face, the cutting recess configured to receive therein the cutting insert.

2. The rotary cutting tool of claim 1, wherein the cutting recess comprises a flexure, a fulcrum, and a clamping face.

3. The rotary cutting tool of claim 2, wherein the flexure, the fulcrum, and the clamping face are structured collectively to provide a clamping force operable to secure the cutting insert against the cutting face.

4. The rotary cutting tool of claim 3, wherein the cutting insert is secured between the flexure and the clamping face.

5. The rotary cutting tool of claim 3, wherein the fulcrum is configured to bias the flexure against the cutting insert.

6. The rotary cutting tool of claim 1, wherein the cutting recess comprises a substantially V-shaped forward surface configured to secure therein the cutting insert.

7. The rotary cutting tool of claim 1, wherein the cutting recess comprises a cam receptacle sizably configured to engage with a cam tool.

8. The rotary cutting tool of claim 7, wherein the cam tool is configured to, while so engaged with the cam, release a clamping force of the cutting recess.

9. The rotary cutting tool of claim 1, wherein the cutting insert comprises a substantially V-shaped rearward surface configured to engage with the cutting recess.

10. The rotary cutting tool of claim 1, wherein the cutting insert comprises a cutting edge extending outwardly in a direction relative to the cutting face, defining a positive rake angle.

11. The rotary cutting tool of claim 1, further comprising a plurality of cutting recesses, the plurality of cutting recesses extending axially into the substantially cylindrical body from the cutting face.

12. The rotary cutting tool of claim 11, wherein the plurality of cutting recesses are spaced equidistantly about a periphery of the cutting face.

13. The rotary cutting tool of claim 1, further comprising a fastener, wherein an insert fastener hole is defined in the cutting recess, and wherein the insert fastener hole receives the fastener to releasably secure the cutting insert to the cutting recess.

14. The rotary cutting tool of claim 13, wherein the fastener is a threaded bolt and the recess fastener hole is a threaded hole.

15. The rotary cutting tool of claim 13, wherein the fastener directly secures the cutting insert to the cutting recess.

16. The rotary cutting tool of claim 15, wherein the cutting recess defines a concave cutting relief extending from the cutting face of the substantially cylindrical body to a base of the cutting recess, and wherein the cutting insert comprises an insert base engaging the base of the cutting recess.

17. The rotary cutting tool of claim 16, wherein the cutting recess defines a concave locating feature, the concave locating feature defining an anti-rotation feature, and wherein the cutting insert defines a locating feature with a shape that is complementary to the anti-rotation feature of the locating feature of the cutting recess.

18. The rotary cutting tool of claim 17, wherein the anti-rotation feature is defined at a midpoint of the locating feature of the cutting recess and the anti-rotation feature defines a radius of curvature that is smaller than a radius of curvature of the locating feature of the cutting recess.

19. The rotary cutting tool of claim 13, wherein the fastener and the insert fastener hole extend in a direction parallel to the center axis of the substantially cylindrical body.

20. The rotary cutting tool of claim 13, wherein:
the cutting insert comprises an insert base defining a bolt portion;
the bolt portion defines an insert fastener hole; and
the fastener extends through the insert fastener hole to engage the recess fastener hole of the cutting recess.

21. A cutting tool comprising:
an annular body rotatably centered about an axis, the body defining a distal end and a proximal end, the proximal end comprising a cutting face;
a plurality of cutting recesses defined circumferentially about the cutting face, each cutting recess defining a void; and
a plurality of cutting inserts, each cutting insert disposed in the void of each cutting recess, each cutting insert sizably configured to form an interference fit with each void.

22. The cutting tool of claim 21, wherein the distal end of the annular body is configured to engage with a power tool.

23. The cutting tool of claim 21, wherein each cutting insert is canted relative to each cutting recess to define a rake angle.

24. The cutting tool of claim 21, wherein the interference fit of each cutting insert is configured to provide a clamping force which is operable to retain each cutting insert within the void of each cutting recess.

25. The cutting tool of claim 24, wherein each cutting insert, when engaged with a work surface, is configured to increase the clamping force of the interference fit.

26. The cutting tool of claim 21, further comprising a cam tool and a cam receptacle proximal to each cutting recess, the cam tool configured to engage the cam receptacle and temporarily disrupt the interference fit.

27. The cutting tool of claim 21, wherein the body comprises a sintered metallic material.

28. The cutting tool of claim 21, wherein the cutting insert comprises tungsten carbide.

29. The cutting tool of claim 21, wherein each cutting recess further comprises a locating feature that engages each cutting insert and is configured to locate each cutting insert relative to each cutting recess.

30. A method of securing a cutting insert to a rotary tool, the method comprising:
providing a rotary cutting tool comprising a substantially cylindrical body, a cutting face, a cutting recess, a cam tool, and a first cutting insert;
engaging the cam tool with the rotary cutting tool at the cutting recess;
articulating the cam tool to elastically deform the cutting recess and release a clamping force;
replacing the first cutting insert with a second cutting insert; and
releasing the cam tool.

31. The method of claim 30, wherein the cam tool is rotated in the cutting recess.

32. The method of claim 30, wherein the first cutting insert defines a first shape, and the second cutting insert defines a second shape that is different from the first shape.

33. The method of claim 30, wherein the first cutting insert is configured to cut a first material and the second cutting insert is configured to cut a second material that is different from the first material.

34. A method of securing a cutting insert to a rotary tool, the method comprising:
providing a rotary cutting tool comprising a substantially cylindrical body, a cutting face, a cutting recess, a cutter bolt, and a first cutting insert;
articulating the cutter bolt to selectively tighten or loosen the cutter bolt to modulate a holding force provided therefrom;
disengaging the cutter bolt with from the cutting inter;
replacing the first cutting insert with a second cutting insert; and
reengaging the cutter bolt with the cutter insert.

35. The method of claim 34, further comprising replacing the cutter bolt with a replacement cutter bolt.

36. The method of claim 34, wherein the cutter bolt is configured to be engaged with a tool.

37. The method of claim 34, further comprising the step of sharpening the cutting insert.

38. The method of claim 34, further comprising applying a thread locker to the cutter bolt.
